(19) United States
(12) Patent Application Publication
(10) Pub. No.: US 2012/0109735 A1
(43) Pub. Date: May 3, 2012

(54) Mobile Payment System with Thin Film Display

(76) Inventors: Mark Stanley Krawczewicz, Annapolis, MD (US); Jay Steinmetz, Baltimore, MD (US); David Eagleson, Severna Park, MD (US)

(21) Appl. No.: 13/278,126

(22) Filed: Oct. 20, 2011

Related U.S. Application Data
(63) Continuation-in-part of application No. 13/108,949, filed on May 16, 2011.
(60) Provisional application No. 61/394,939, filed on Oct. 20, 2010.
(60) Provisional application No. 61/334,748, filed on May 14, 2010.

(51) Int. Cl. G06Q 20/04; G06Q 30/02; G08B 13/14

(52) U.S. Cl. 705/14.27; 340/572.7; 705/35

(57) ABSTRACT

A flexible stored value label has within it an integrated thin film flexible display and has RFID and security capabilities. In another embodiment, the present invention is a stored value payment system. The label has a secure processor with a memory, a near-field antenna connected to the processor and a bi-state display and a flexible encapsulation layer encapsulating the secure processor, the near-field antenna and the bi-state display. The encapsulation layer has a window through which information displayed on the bi-state display may be viewed. The secure processor and the display are powered solely by energy received through the near-field antenna and the label conforms to a shape of a non-planar surface of an object to which it is attached.

### CROSS-REFERENCE TO RELATED APPLICATIONS

The present application claims the benefit of the filing date of U.S. Provisional Application Ser. No. 61/394,939 entitled “Mobile Payment and Loyalty Thin Film Display Labels for Non-Conforming Applications” filed by the present inventors on Oct. 20, 2010, and is a continuation-in-part of U.S. nonprovisional patent application Ser. No. 13/108,949 entitled “Batteryless Stored Value Card with Display” and filed by Mark Krawczewicz on May 16, 2001, which claims the benefit of U.S. Provisional Patent Application Ser. No. 61/334,748 filed on May 14, 2010.

The above cross-referenced related application is hereby incorporated by reference herein in its entirety.

### STATEMENT REGARDING FEDERALLY SPONSORED RESEARCH OR DEVELOPMENT

None.

### BACKGROUND OF THE INVENTION

1. Field of the Invention

The present invention relates to generally to RFID cards, and more specifically, to a batteryless RFID labels having a display, a stored value, and customer loyalty data.

2. Brief Description of the Related Art

In recent years, RFID cards are tags have become increasingly prevalent. The have been incorporated into many diverse fields. For example, RFID readers and cards have been incorporated into bill/coin acceptors (U.S. Pat. Pub. No. 2009/0321516 and 2009/0218395), tracking systems (U.S. Pat. Pub. Nos. 2010/0066497 and 2010/0019905), authenticatable badges (U.S. Pat. Pub. No. 2009/0289762), commodity displays (U.S. Pat. Pub. No. 2009/0295749) and luggage tags (U.S. Pat. No. 7,845,569). Advances have been made in some instances to provide RFID cards that receive power from a host device rather than having a battery incorporated into the card (U.S. Patent App. Pub. Nos. 2010/0033310, 2010/033307 and 2009/0206994).

Recently, efforts have been made to incorporate displays into RFID cards and tags. For example, in U.S. Patent App. Pub. No. 2010/0052908 entitled “Transient State Information Display in an RFID Tag,” a display is incorporated into an RFID card to show a transient state such as an age of a product. In the preferred embodiment disclosed in that patent, a card or tag reader provides a current date while the card provides the expiration date of the product. Based on a comparison of those two, an LED is illuminated to reflect the status of the product. The disclosure indicates that a variety of other types of displays may be used and also that the card may be active or passive. In another example, U.S. Patent App. Pub. No. 2010/0079416 entitled “Radio Frequency Identification (RFID), Display Pixel, and Display Panel and Display Apparatus Using RFID Display Pixel” discloses an RFID tag connected to an “RFID pixel” or plurality of “RFID pixels.” Another example is described in U.S. Patent App. Pub. No. 2009/0309736 entitled “Multifunction Contactless Electronic Tag for Goods.”Additionally, WO 00/36560, published on Jun. 22, 2000, discloses an electronic ink display media for security and authentication. In this document an electrophoretic display medium and an supplementary authentication marker is disclosed.

### SUMMARY OF THE INVENTION

A batteryless RFID label comprising a flexible housing, means for attaching the flexible housing to a non-planar surface of an item, a secure processor with a memory, a near-field antenna connected to the processor, a display control circuitry connected to the processor and a bi-state display connected to the secure processor. The secure processor is solely powered by energy received through the near-field antenna. The flexible housing conforms to a shape of a non-planar surface of an object to which it is attached. The batteryless RFID label further comprises a bi-state display in the housing, wherein the bi-state display is connected to the secure processor and is solely powered by energy received through the near-field antenna. The attachment means comprise one of an adhesive, a magnet and a clamp. The circuit comprises an encapsulation layer and wherein circuit is a circuit in-lay layer. The circuit in-lay layer and the encapsulation layer form the label. The circuit in-lay layer may comprise a printed Teslin layer. The label may be attached, for example, to a coffee mug, cell phone or media player. The bi-state display may comprise a multi-line display.

In another embodiment, the present invention is a stored value payment system comprising a label. The label comprises a flexible encapsulation, means, such as an adhesive layer, a magnetic backing, for attaching the label to a non-planar surface of an object, a circuit having a secure processor with a memory, a near-field antenna connected to the processor and a bi-state display. The secure processor and the display are powered solely by energy received through the near-field antenna. The flexible encapsulation conforms to a shape of a non-planar surface of an object to which it is attached. The information shown on the display may comprise an earned reward, a monetary or non-monetary remaining value, information of prior use of the stored value payment system such as a prior number of cups of coffee used or a date of a use of the system or last visit to a store, or any other type of useful information. The encapsulation may comprise a printed Teslin layer. The label may be attached to any item, such as a coffee mug, cell phone, media player, purse or item of clothing.

In another embodiment, the present invention is a stored value payment system. The system comprises a label. The label comprises a secure processor with a memory, a near-field antenna connected to the processor and a bi-state display and a flexible encapsulation layer encapsulating the secure processor, the near-field antenna and the bi-state display. The encapsulation layer has a window through which information displayed on the bi-state display may be viewed. The secure processor and the display are powered solely by energy received through the near-field antenna and the label conforms to a shape of a non-planar surface of an object to which it is attached.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIGS. 1A and 1B are diagrams of stored value cards in accordance with a preferred embodiment of the present invention.

FIG. 2A is a diagram of an alternate embodiment of a card in accordance the present invention being used as a cryptographic unlocking key for a mobile phone or PDA device.

FIG. 2B is a diagram of an alternate embodiment of a card in accordance the present invention being used as a cryptographic unlocking key for a laptop computer or other portable device.

FIG. 3 is a block diagram of a stored value card in accordance with a preferred embodiment of the present invention.

FIG. 4 is a block diagram of a security processor in a preferred embodiment of the present invention.

FIG. 5A is a cross sectional view of an E-ink bi-state display in accordance with a preferred embodiment of the present invention.

FIG. 5B is a cross sectional view of an electrophoretic bi-state display in accordance with a preferred embodiment of the present invention.

FIG. 5C is a cross sectional view of an electrochromic bi-state display in accordance with a preferred embodiment of the present invention.

FIG. 6A is a diagram of an embodiment in accordance with the present invention of an RFID card having two antennas.

FIG. 6B is a diagram of an embodiment in accordance with the present invention of an RFID card having one antenna.

FIG. 7A is a schematic diagram of a rewards label and coffee mug in accordance with a preferred embodiment of the present invention.

FIG. 7B is a schematic diagram of a rewards label in accordance with a preferred embodiment of the present invention.

FIGS. 8A and 8B are illustrations of a reward label in accordance with a preferred embodiment of the present invention attached onto exemplary coffee mugs.

FIG. 9 is a diagram of a multi-line display of a reward label in accordance with a preferred embodiment of the present invention.

FIG. 10 illustrates of a label on a portable item such as a cell phone in accordance with an alternative preferred embodiment of the present invention.

### DETAILED DESCRIPTION OF THE PREFERRED EMBODIMENTS

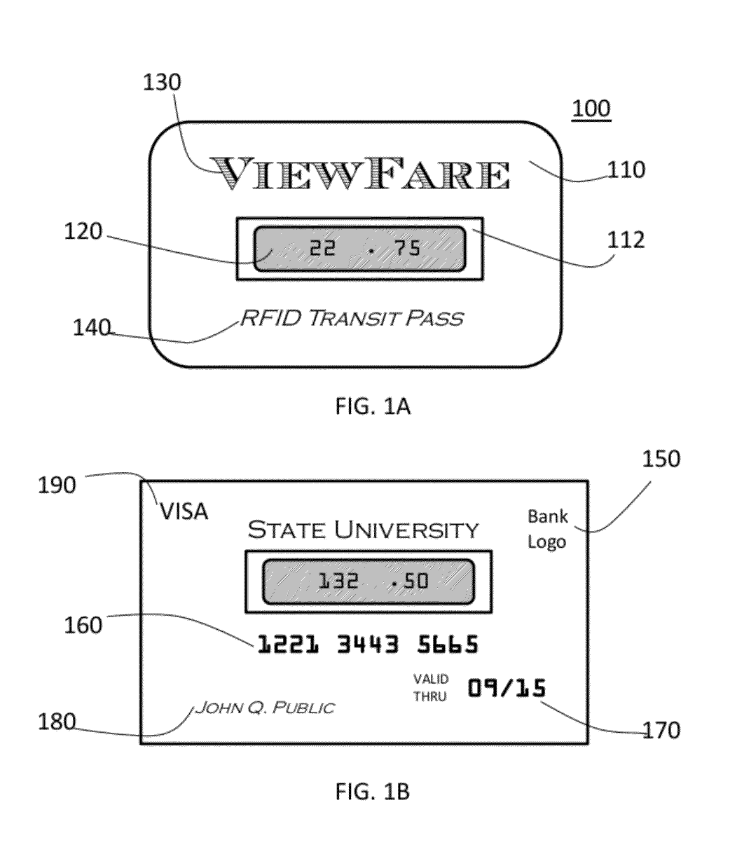

Preferred embodiments of the present invention will be described with reference to the drawings. A stored value card such as a transit card (FIG. 1A), college meal plan card or other card such as a pre-paid or other credit card (FIG. 1B) has within it an integrated thin film flexible display and has RFID and security capabilities. The card 100 has a housing 110 having a display window 112 in which there is a display 120. The card may have various types of information printed on either side of the card. Such information may include, for example, a trademark 130, descriptive information 140, a bank logo 150, a credit card number 160, an expiration date 170, a name 180 or a card type 190. Other types of information such as photos, pictures, address or telephone information, of course may also or alternatively be printed on the card.

In a preferred embodiment of a stored value card in accordance with the present invention, the display shows a remaining balance on the card. In other card embodiments, the display can show many other items, such as an authentication status, a payment status or an entertaining message such as a horoscope or a message of the day. While coupled to a reader, the display also may be used to show a scrolling or multiple line message. The messages may be received from the reader or may be pre-stored in memory on the card.

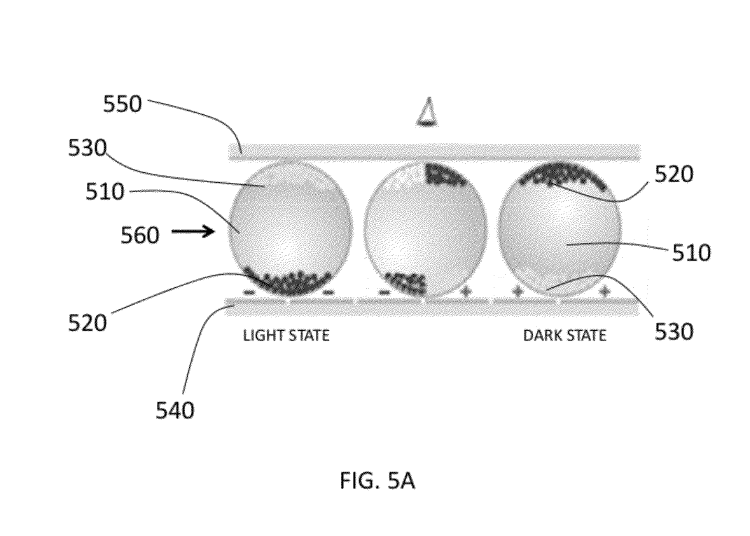

The card or tag may be encapsulated using commercially available techniques such as used by Vanguard Identification Systems, Inc. in Westchester, Pa. (see also, U.S. Pat. No. 7,584,896). The display in a preferred embodiment is a bi-state display that does not require power to maintain the display after each use. Rather, the display is changed at the time a transaction occurs. Further, the cards in a preferred embodiment of the present invention may be designed to be interoperable with existing contactless card readers and infrastructure. As shown in FIG. 5A, the display may be, for example, an electrophoretic layer or assembly comprised of a back plane, a top plane, and an electrophoretic material positioned in between the two. In a preferred embodiment, the bottom plane is an electrical circuit layer and the top plane is a transparent conductive plastic layer.

The display and support circuitry will integrate into standard ISO card with reverse capability with magnetic strip, contactless payment readers. The traditional cards have many known security vulnerabilities and this secure display card mitigates these security issues.

The secure payment card of the present invention has two way contactless communication with the payment terminal without the use of a battery. Data is transferred between the card and a reader via modulation in the inductive field. Additionally, the new technology utilizes a secure processor within the card to secure the interface, protect the data stored within the card, and authenticate the user to the card. The complete display and circuitry is encapsulated within the plastic of the card that can provisioned with any company and personalization branding or other printed information.

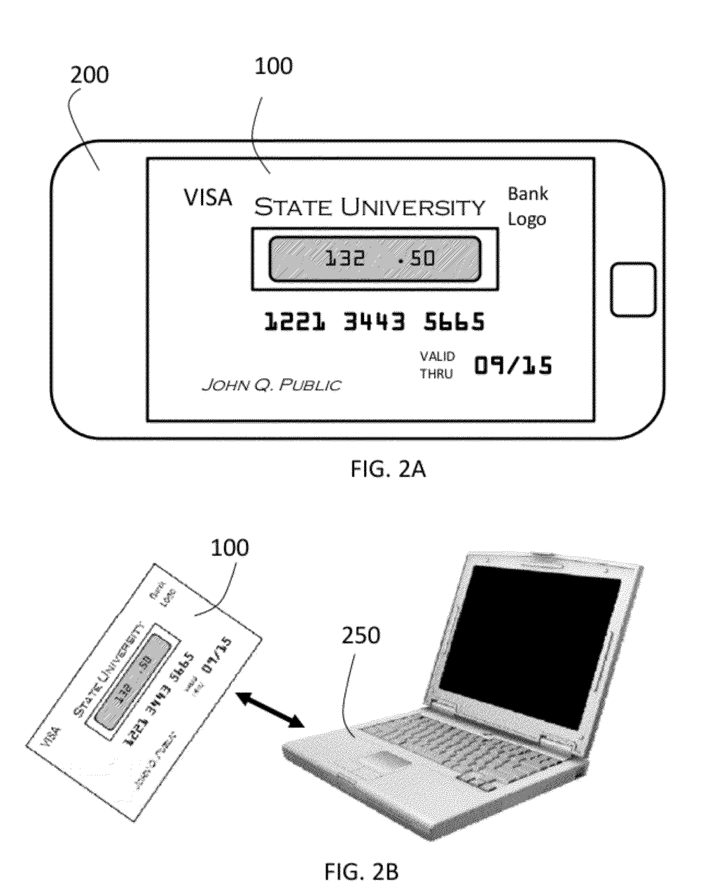

The new class of card has many applications, including but not limited to the following:
as a stored value card for applications like transit fare card, college student meal plan card, or other similar applications (FIG. 1). These applications are designed to interact with traditional retail payment terminals or payment kiosks.
as a cryptographic unlocking device “key” for a mobile phone or PDA device or with a laptop or desktop computer (FIGS. 2A and 2B). In both applications, the mobile device or computer acts as the communications link and hosts the secure payment portal running the payment application (i.e. airline website for ticket purchase).

In these two exemplary applications, the display card interaction occurs twice in the transaction. First, to execute a cryptographic challenge response to mutually authenticate the reader/card and to authenticate the user to the card. This process unlocks the cryptographic keys to verify the application running on the mobile phone or computer has not been modified. Second, the payment process is executed between the mobile phone or computer application and the bank or credit card authorization center. This session between the mobile application and the card authorization centers is secure using the session keys provided by the secure display card. Upon payment verification, a message will be sent to the card such as “APPROVED” to positively verify to the cardholder all steps of the transactions were secured and processed.

Mobile Payment Trends Driving this Proposed Architecture:

Recently, there has been a focus on developing mobile payment applications—with the objective of using the phone as a credit card. In connection with those efforts, NFC antennas within phones to interface with the payment terminal.

The main deficiency with this concept is the cell phones' applications and keys stored on the phones to unlock the payment application are not protected. What is needed to address this shortfall is a card to unlock, authenticate, and verify a transaction of the cell phone payment application and used as a communication channel.

Traditional payment interfaces like magnetic strip or contact 7816 card readers are not optimal or practical for integration into mobile devices like cell phones. Recently, NFC (14443) receivers have been embedded in the next gen phones.

An embodiment of the present invention utilizes the NFC in a novel way to bridge credit/debit cards with mobile phones for secure transactions, as shown in FIGS. 2A and 2B. FIG. 2A illustrates a card 100 of the present invention adjacent a mobile phone 200 while FIG. 2B shows a card 100 adjacent a laptop computer 250. In addition, this same card technology will operate as a standard card, or stored value card for applications such as; parking, college meal plane cards, season ticket cards, and well as numerous not-thought-of-yet applications.

This new class of card inlay can easily embed in ISO standard cards. The solution encompasses has some key technology features. First, the circuitry is powered and communicates entirely from the NFC reader—meaning no battery. Batteries are problematic in integration, reliability, and have a fixed lifetime. Second, the inlay incorporates, for example, a 10 bit alpha numeric display to show the cardholder anything from how much money is left on their college meal card or pre-paid card, the current balance charged on a credit card, or to display text like “APPROVED” visually showing to the cardholder, the transaction being executed on the mobile phone, computer, or standard payment terminal was processed.

The common Interface—Near Field Communications

NFC is the most promising contactless technology enabling wireless connections between two devices, e.g. a mobile phone and a payment, without having to navigate through complicated menus or performing complex set-up procedures. NFC is already internationally in used between a card & stationary reader for access control and public transport. The principle of NFC is to make two devices communicate and connect based on 13.56 MHz radio frequency technology making it backwards compatible with ISO 14443.

NFC was invented as a communication channel, but when introduced for payment transactions, security had to be added. This is done using a secure micro processor in the card. Thus, it supports almost all of today's major contactless smart cards schemes. NFC-enabled devices can act as both contactless card and reader, supporting peer-to-peer communication.

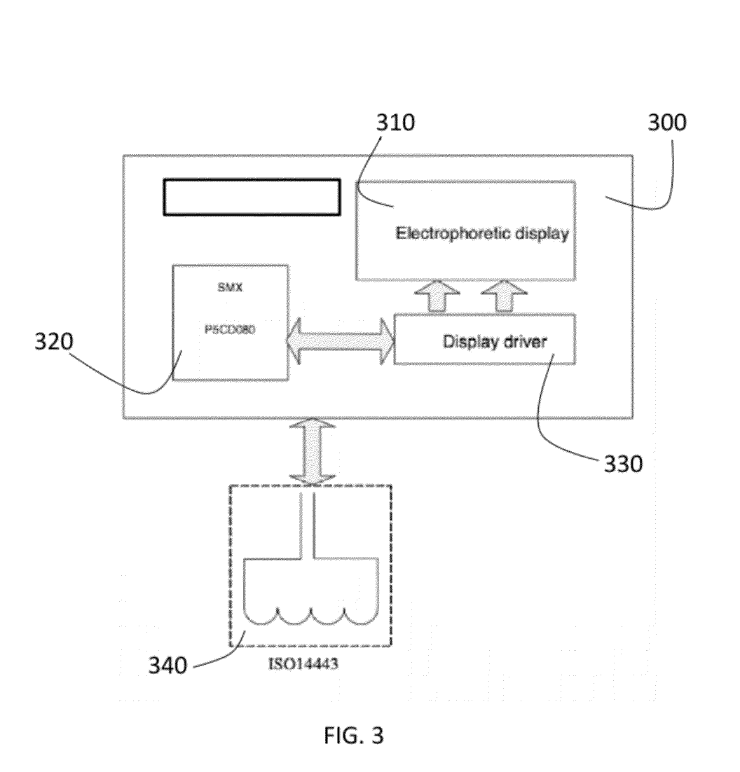

A thin flexible display assembly 300 has circuitry comprised of the functional components in FIG. 3. A bi-state display 310 is changed and update from power & data from the merchants RFID reader payment terminal. The display 310 will stay in the state it was written to until power and data are applied during the next payment or reward redemption transaction. Internal circuitry includes a secure processor 3200 that interfaces with inlay antenna 340 and the drive circuitry 330 for switching the bi-state display 310. The configuration of inlay components does not require an internal battery allowing the display assembly to operate for years. The near field communication (NFC) antenna 340 couples power and data electromagnetically from the coil of the reader to the components within the card 310 that require power, such as the display 310, the driver 330 and the processor 320. Based upon a modulation frequency of 13.45 MHz and using a standard baseband protocol defined as ISO 14443, a preferred embodiment of the invention was designed to work entirely through existing NFC RFID hardware. Internal chip memory encrypts and protects biometrics, user photo or biographical data, flight information, etc.

In a preferred embodiment of the present invention, the display circuitry or assembly 300 is fully encapsulated in a housing formed of a composite layer of Teslin™, and then a polyester plastic. The outer surface of the Teslin is printed using a digital reverse dye sublimation, heat transfer, or any traditional ink process to create the graphics or print on the Teslin. The area were the display 310 is located is cut out in the Teslin. The cutout may be large enough to include all of the lines of the display or there may be a separate cutout for each line of the display. The inlay 300 is attached from the inside and aligned with the cut-out window. The Teslin layer provides excellent thermal barrier from excessive hot & cold temperatures.

The polyester layer serves two functions. First, it provides a transparent or clear protective window on top of the display panel area 3100. Second, it acts a general protective barrier for the circuit display inlay from water and chemicals. The inlay display circuitry shown in FIG. 3 may be modified to facilitate multi-line display as to align with additional data.

### The Card

Each NFC system with the card has an antenna with innate capacitive and resistive values which affects the capacity to inductively couple in power and transmit data.

HF antenna—The data read range is very short around 4 inches (10 cm), with a baud rate of 106 kilobaud as defined by the ISO 1443 standard, yet most often read just beyond the actual contact zone of the interrogator.

### Antenna

The card is passive because it cannot generate and reflect radio signals to an interrogator if is not in the presence of an electromagnetic (EM) field. The inlay must be inside the interrogation zone in order to receive enough power to generate a response. The initial interrogator signal powers the inlay's circuitry, allowing communication.

### The Display

The display in a preferred embodiment is a bi-state display that does not require power to maintain the display after each use. Rather, the display is changed, for example, at the time the card is used. Further, the cards in a preferred embodiment of the present invention may be designed to be interoperable with existing contactless RFID readers and infrastructure.

As shown in FIG. 5A, the display 500 may be, for example, an electrophoretic layer or assembly comprised of a back plane 540, a top plane 550, and an electrophoretic material or layer 560 positioned in between the two. In a preferred embodiment, the bottom plane 540 is an electrical circuit layer and the top plane 550 is a transparent conductive plastic layer. In a preferred embodiment, the display is an E-Ink bistable display based on electrostatic charges used to affect tiny spheres suspended in a plane. The spheres 510 are electrostatically charged with a black half 520 carrying the negative charge and a white half 530 carrying the positive charge. Two electrodes surround the plane; the front one transparent. When a charge is placed across the electrodes the spheres 510 rotate to align with the front-to-back charge gradient. Because the spheres 510 are suspended in a semi-solid when the power is removed, they remain in that position and the display continues to show whatever design or text it showed before power was removed. Thus, the display does not require any power to keep its visible information. In a preferred embodiment, the display may contain, for example, 10 alpha-numeric digits and two decimal points. The software at the secure controller can drive the display through a supplied SW library

In another embodiment, an SiPix display is used. The SiPix display, shown in FIG. 5B, is a variant of a plastic Electrophoretic display that is thin and flexible and uses a microcup structure to hold electronic ink stable. SiPix's microcup technology involves a microscale container which holds minute quantities of fluid and particles.

The display structure, typically 150 μm thin, is built upon a flexible PET plastic substrate, which may include a transparent conductor such as Indium Tin Oxide (ITO). The contents of the microcup are hermitically sealed to protect them from the environment. Similar electrodes on both either side change position and orientation of material suspending in a gel like fluid. SiPix is also an Electrophoretic a reflective display that uses electrophoresis to switch pixels or segments on and off. Electrophoresis is the motion of charged particles suspended in a liquid in response to an electric field. If the white particles migrate to the visible surface, the display exhibits the color white.

In yet another embodiment, the bi-state display is a spiral crystal LCD technology that reflects almost all the image light cast on it while attenuating most of the ambient light to produce a bright reflected display. Cholesteric materials are liquid crystal that is a type of liquid crystal with a helical (smooth curve like a spiral) structure. Cholesteric liquid crystals are also known as chiral nematic liquid crystals have molecules that maintain their orientation. Some substances exist in an odd state that is similar to both liquid and solid. When they are in this state, the molecules tend to maintain their orientation, like solids, but can also move like a liquid. Liquid crystals are such materials. However, in essence they are more like a liquid and require only a little heat to move from this odd state to a liquid state. A feature of liquid crystals is that they are affected by electric currents. Depending on the temperature and particular nature of a substance, liquid crystals can be in one of several distinct phases, including nematic phase and the cholesteric phase. LCDs use these types of crystals because they react predictably to electric current in such a way as to control light passage

In still another embodiment, an electrochromic display is used. The display is comprised of a layer of electrochromic material sandwiched between two electrode layers, as shown in FIG. 5C. The material changes from one color to another when stimulated by an electric current. The top electrode layer is made from transparent plastic, so the display can be seen clearly through it.

The chemical reaction at work is an oxidation reaction—a reaction in which molecules in a compound lose an electron. Ions in the sandwiched electrochromic layer are what allow it to change from opaque to transparent. It's these ions that allow it to absorb light. A power source is wired to the two conducting oxide layers, and a voltage drives the ions from the ion storage layer, through the ion conducting layer and into the electrochromic layer. This makes the glass opaque. By shutting off the voltage, the ions are driven out of the electrochromic layers and into the ion storage layer. When the ions leave the electrochromic layer, the window regains its transparency.

### Thickness

The maximal thickness of the module, its components and the display is about 300 micro meter, except for some SMD components that have a thickness of 400 micrometer. The thickness is very suitable for embedding in a standard ISO thickness card (800 micron).

### Materials

Inlay: FR-4 (glass-epoxy-laminate) thickness: 100 micron (excluding copper tracks) Module base material: Polyimide, thickness: 25 micron Display front material: PET (Polyethylene Therephthalate), thickness: 125 micron

Note: all materials have a CTE (Coefficient of Thermal Expansion) of ±18 ppm/oC.

### Secure Processor:

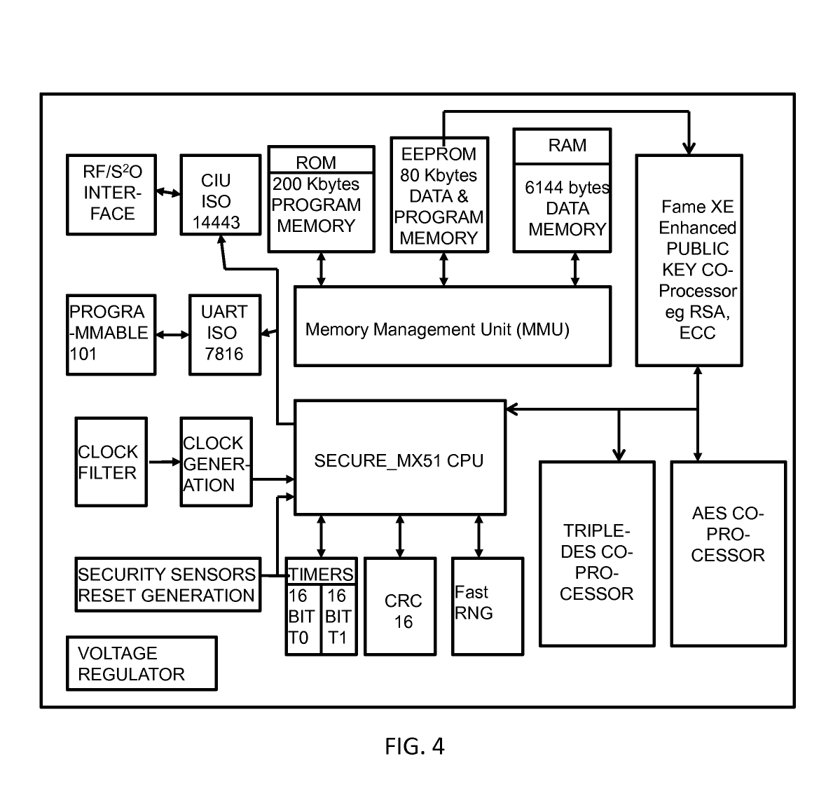

A block diagram of an exemplary security processor of the secure display device is shown in FIG. 4. The security processor includes 96 Kbytes of ROM, 4608 bytes of RAM (data memory) and 18 Kbytes of EEPROM, which can be used as data memory and as program memory. On-chip program memory has up to 8 Mbytes and additional instructions has been added to the 8051 instruction set to support the extended addressing concept and improve the code efficiency with C programming.

Interface execution speed and enhanced functionality and expanded on-chip memory configurations of more than 500 Kbytes. Functions including the operation of DES and AES are fully operational on the contactless interface.

The contactless interface data, processing data within the card, and data storage are protected with an embedded security processor with an international assurance rating of EAL+5 (Evaluation Assurance Level) based upon the common criteria for information security. This security assurance can only be achieved with a series of hardware/software features.

Interface to any security authentication protocol or encryption systems are easily achieved through non-proprietary firmware on the processor.

Security Features to Achieve EAL+5 include, but are not limited to, the following:

Supports public key cryptography based on finite fields of prime order—GF(p)

Supports RSA with an operand length of up to 5 kBits and related standards (PKC#1 [RSA], PKC#3 [Diffie-Hellman] and FIPS186-2 [DSA&EC-DSA], IEEE P1363).

An integrated Hardware 3DES accelerated in incorporated into the processor chip DES3 performance: <50 μs. The Digital Encryption Standard (DES) for symmetric encryption is still used in most applications today and is supported by a dedicated, high performance, highly attack resistant co-processor. Single DES and triple DES, based on two or three DES keys, can be executed within less than 50 μs. Relevant standards (ISO, ANSI, FIPS) and Message Authentication Code (MAC) are fully supported. The use of the embedded DES co-processor increases execution speeds to a level where the actual time needed for a DES encryption becomes entirely irrelevant for an application.

To further protect and prevent reading while encrypting data or while in memory, countermeasures incorporate a range of security features to counter measure side channel attacks like DPA, SPA etc.

A Low power Random Number Generator (RNG) is implemented in hardware, FIPS140-2 compliant

Power-up/Power-down reset•Low/high supply voltage sensor•Low/high clock frequency sensor•Low/high temperature sensor•Light sensor•Single Fault Injection (SFI) attack detection•EEPROM programming:

No external clock—hardware sequencer controlled—on-chip high voltage generation

Electronic fuses for safeguarded mode control

Unique serial number for each die

32 bytes Write Once Security area in EEPROM (bit access)

14 bytes User Write Protected Security area in EEPROM (byte access, inhibit functionality per byte)

32 bytes User Read Only area in EEPROM (byte access)

64 or 128 EEPROM bytes for customer-defined Security FabKey. Featuring batch-, wafer- or die-individual security data, incl. encrypted diversification features on request

Clock Input Filter for protection against spikes

Memory protection (encryption and physical measures) for RAM, EEPROM and ROM

The inlay integrates the SmartMX are microprocessor. The hardware does nothing on its own, it has to be programmed with dedicated software—an operating system. Most of the time, the microprocessor is coupled to a co-processor dedicated to fast cryptographic computations (i.e, Triple DES or AES). The processor capable of executing complex operations that are as secure and fast as operations on contact based cards and slower through the RFID interface. Both the contacts or multiple interfaces can be connected. The processor is capable of supporting a range of both proprietary and open operating systems, including the Java Card™ operating system (JCOP).

Depending on the installed software, this processor is mostly used where a high level of security is required (i.e., secure travel documents, electronic passports, payment cards, etc.), and is certified by independent parties such as Common Criteria. The hardware of the SmartMX processor is Common Criteria certified at EAL5+ by the BSI, which means that it is highly resistant to tampering such as, for instance, reverse engineering attacks, fault/glitch attacks, or power analysis attacks.

NFC is the preferred interface for mobile payments for ease of use between credit cards or bank card. FIG. 5 illustrates next generation web enabled phones and computers with integrated NFC communications hardware. This will allow the mobile device and computers to act as a secure payment terminal.

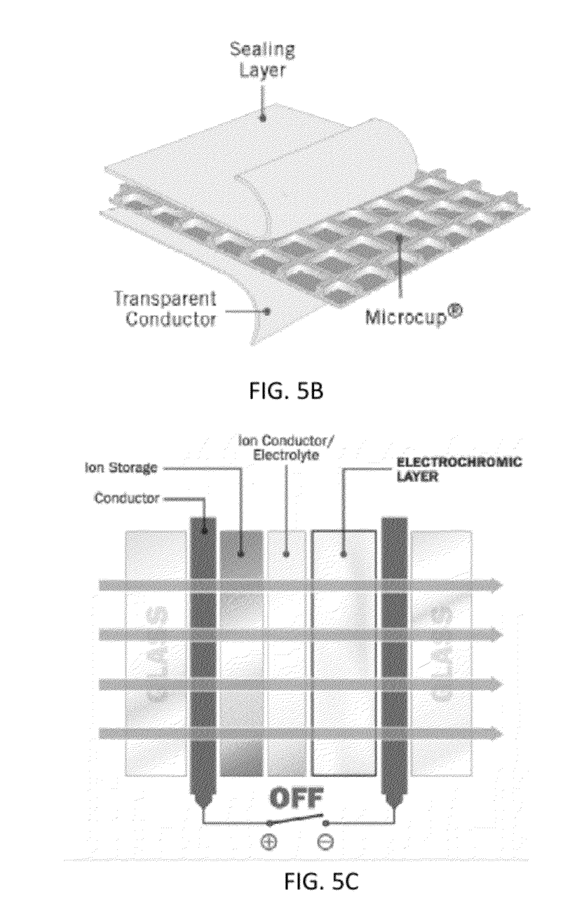

In another embodiment of the present invention, the RFID card has both a near-field antenna and a UHF antenna. In such a system, the UHF antenna may be used solely for reading information while the near-field antenna can be used to change the display. As shown in FIG. 6A, the card 600 has both a near-field antenna 620 and a UHF antenna 630. In such a system, the UHF antenna 620 may be used solely for reading information while the near-field antenna 630 can be used to provide power to change the display 610 via driver chips 640 and to power the processor and memory. In FIG. 6A, there also is shown an opening or hole 604 in housing 602, for example, for attaching the card to a key chain or other item. For example, DASH7, a wireless sensor network protocol, uses 433 MHz, a much lower frequency that travels further with less interference. DASH7 has a multi-kilometer range and with penetration of walls, floors, and water, has a maximum bitrate of 200 kbps, supports tag-to-tag or “multi-hop” communications, sensors, and public key encryption. The shortfalls of DASH7 are that it still requires a battery, it does not support 2-way communications and it is less secure then the passive NFC interface. This DASH7 technology would be an additional option for the UHF antenna.

The card or tag 600 may be encapsulated using commercially available techniques such as used by Vanguard Identification Systems, Inc. in Westchester, Pa. (see also, U.S. Pat. No. 7,584,896). Other encapsulating techniques may be used. For example, the Innovatier Corp. (Lakeland Fla.) encapsulation process is both low-temperature and low pressure not damaging the circuitry or display. The process utilizes a flexible urethane elastomer material that becomes structurally integral with the electrical components and display. This process is called Reaction Assisted Injection Molding Process (RAMP) and allows the delivery of gram-level quantities of reaction injection molding material reliably and accurately. Other attributes of RAMP include:
The manufacturing process is a Low-temperature and low-pressure technology can over mold components at 50° C. and less than 25 psi (1.7 Bar)
The “cold” process does not utilize high temperature to activate a bond of the core layer to the overlays, which helps eliminate damage to sensitive electronics.
The urethane elastomeric material embeds materials to flow gaps as small as 0.0005″ with no out gassing which generate localize stress points.
The Highly durable elastomeric core formulations further proved to be extremely, durable and almost impossible to remove without damage
Other process strengths are, low viscosities, minimal injection forces, low shrinkage, and conducive to high-speed manufacturing.

In yet another embodiment a thin flexible display label 650 has circuitry comprised of the functional components in FIG. 6B. A bi-state display 652 is changed and updated with power and data from a merchant's RFID reader payment terminal. The display 652 will stay in the state it was written to until power and data are applied during the next payment or reward redemption transaction. Internal circuitry includes a secure processor 654 that interfaces with inlay antenna 656 and the drive or control circuitry 658 to switch the bi-state display 652.

The configuration of inlay components do not require an internal battery allowing the label to operate for years. The near field communication (NFC) antenna 656 couples power and data electromagnetically from the coil of the reader. Based upon a modulation frequency of 13.45 MHz and using a standard baseband protocol defined as ISO 14443, the invention was design to work entirely through existing NFC RFID hardware.

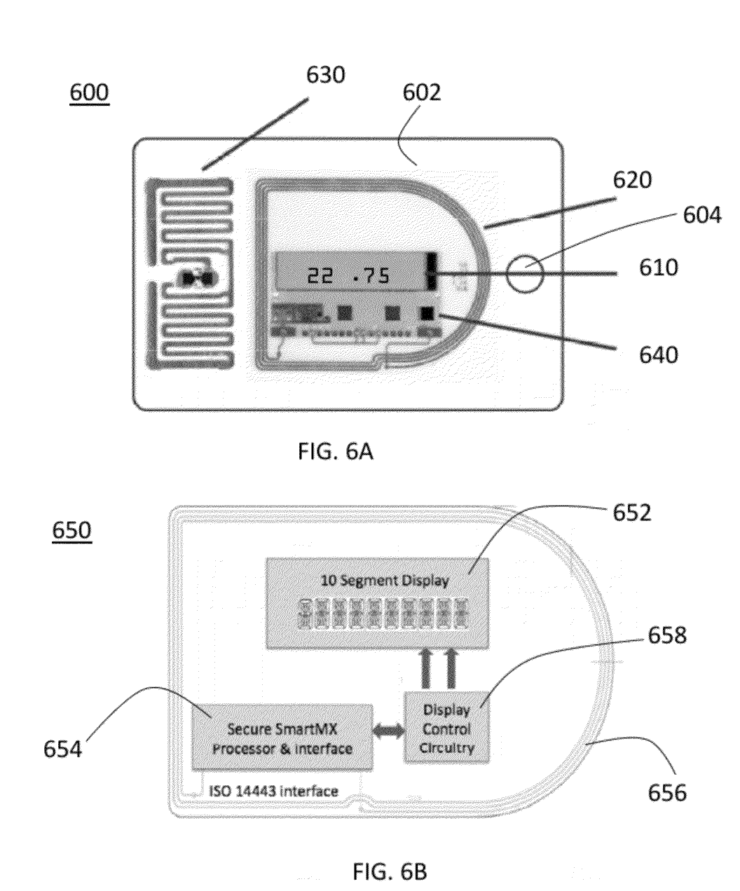

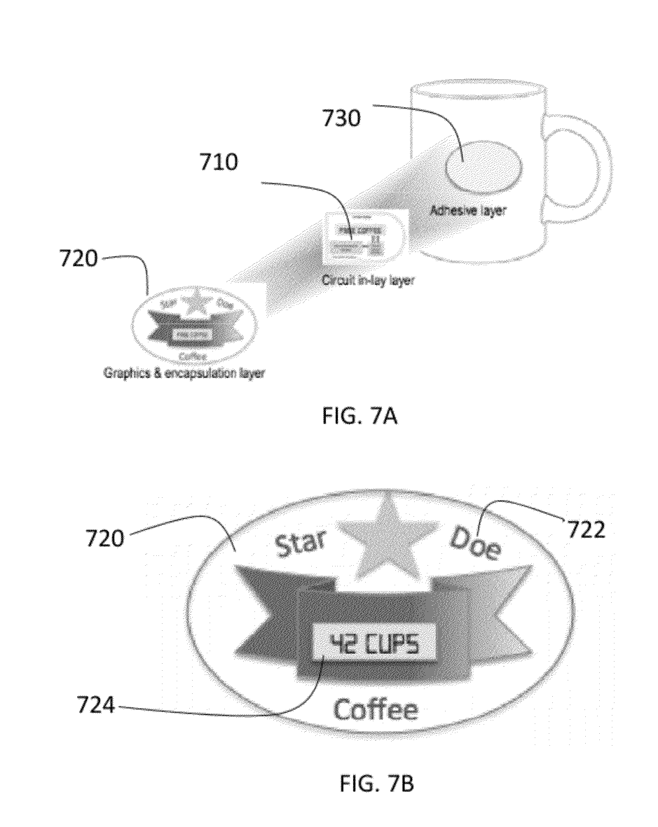

Since the label 720 is thin and flexible, attachment to the coffee mug 810, 812 or other non-planar container or package, as shown in FIGS. 7-8, can be performed by either an adhesive layer 730 or can be part of the lamination assembly process for construction. The adhesive layer can be any known variety of adhesive placed on the back of the label or on the item the label is to be attached to. The label should not be exposed to temperature above 85° C. due to possible display failure.

The display is written via the RFID interface from the payment terminal reader. The payment terminal or reader is assumed secure and trusted therefore all display information is done through the payment software. Audible tones to mark completion of the process, is done by the payment terminal.

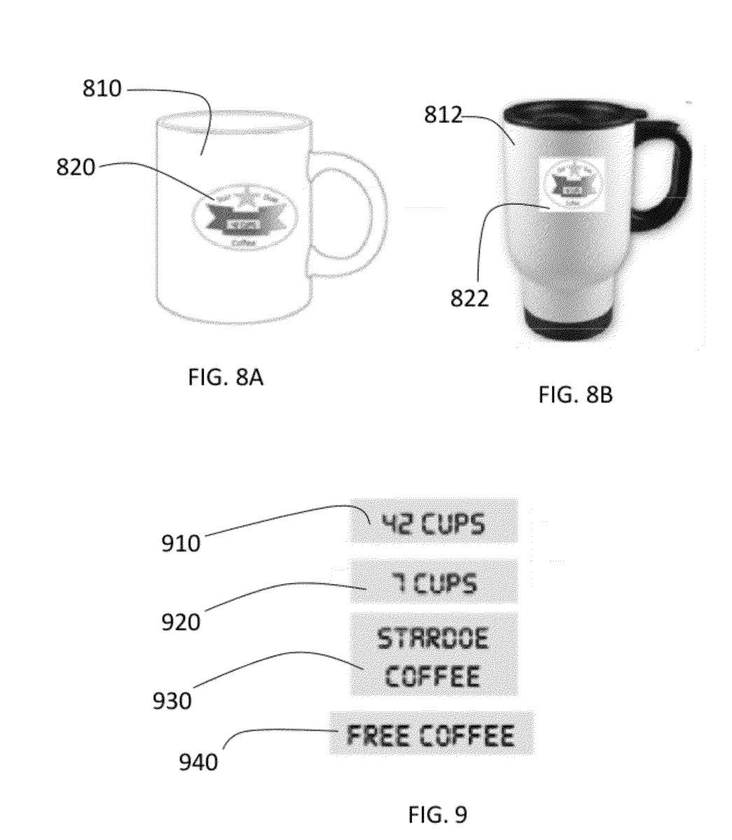

FIG. 9 shows examples a few possible options as to information that may be displayed on the display 724 of a label 720. Two exemplary categories of messages are the following:
(1) Debit pre-paid value messages, which, as shown in FIG. 9, display, for example, the remaining money, cups of coffee remaining 910, cups of coffee purchased 920, brand name 930, or reward 940 within the label. The value amount can be updated and modified at any secure terminal or reader. It could also be pre-loaded with the purchase of a new mug and be used as a replacement of a gift card.
(2) Awards/Rewards/Incentives messages—The mug or container doubles as a loyalty card or token. If the customer used the mug on a more frequent basis, the merchant could “reward’ the loyalty by instantly adding additional free coffee or money on the label.

If the merchant or company has a secure payment portal built into their web site and the customer had a NFC reader on their computer, this invention also provides a means to add additional money or awards/rewards directly from the website to the smart label.

Combining the display label with payment and product provides an opportunity for the vender to brand a product that the frequent customer is essentially a walking billboard. It is for this reason that the display label will be branded with at least the vendor's logo and most likely the bank or credit card company that is processing the payment transaction.

Three-fourths of restaurant operators believe that customer loyalty programs helped to grow their business during the economic downturn, according to an online survey by the National Restaurant Association, which polled 1,300 members. Additionally, nine out of 10 survey respondents say that they feel rewards programs give their business a competitive edge, while 84% plan to maintain or increase their financial investment in these programs through 2010. Customer rewards programs establish brand loyalty by offering incentives and discounts to frequent patrons. Starbucks, for example, lets customers use a prepaid Starbucks card that earns “stars” entitling them to free coffee, coupons and even VIP concert passes. While the Starbucks Card is 6 years old, the rewards program attached to it was rolled out in 2010. Rewards program members who register online already receive free syrup and milk options with drinks as well as free refills of hot and iced brewed coffees and a free drink when they buy a pound of coffee beans. Nearly 14% of all U.S. transactions at Starbucks are paid for using the Starbucks Card. The card's new rewards program gives Starbucks an opportunity to gather personal information on its best customers (if they opt in), including details on what they like to eat and drink, and even when. Starbucks also is looking at ways to put card data on key fobs, cell phones and even travel mugs.

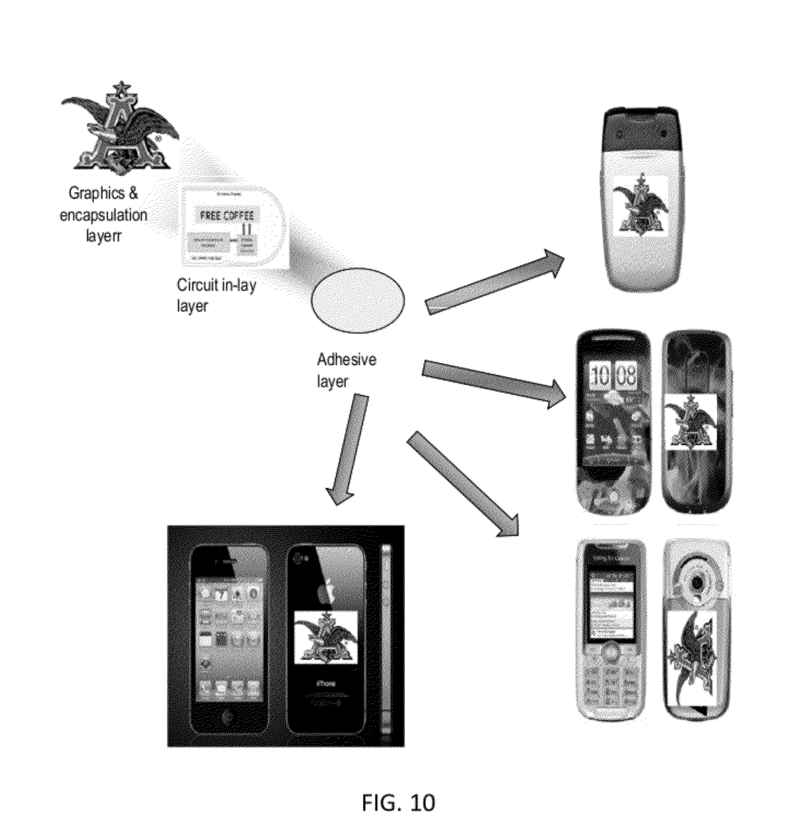

While the preferred embodiment is discussed in terms of a label for an item such as a coffee mug, many other embodiments are possible. For example, as shown in FIG. 10, a label could be placed on or made specifically for a cell-phone, portable music player, portable computer or key chain.

For the reason of a possible display failure as mentioned above the label can be detachable from the surface it is attached to in another embodiment. This can for example be achieved by magnetic means, a clamping device or a removable adhesive. Additionally, the object to which the label is to be attached may have, for example, a window into which the label may be inserted, thereby permitted the label easily to be moved from one item to another. The embodiment is not limited to the aforementioned examples.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A flexible batteryless RFID label comprising:
a flexible housing;
means for attaching said flexible housing to a non-planar surface of an object;
a secure processor with a memory;
a near-field antenna connected to said processor;
a display control circuitry connected to said processor; and
a bi-state display connected to said processor;
wherein said secure processor and said bi-state display are solely powered by energy received through said near-field antenna and said label conforms to a shape of a non-planar surface of an object to which it is attached by said means for attaching.

2. A batteryless RFID label according to claim 1 wherein said attachment means comprise one of an adhesive, a magnet and a clamp.

3. A batteryless RFID label according to claim 1 wherein said processor is within a flexible circuit in-lay layer.

4. A batteryless RFID label according to claim 3 further wherein said circuit in-lay layer and said housing form said label.

5. A batteryless RFID label according to claim 3 further wherein said circuit in-lay layer comprises a printed Teslin layer.

6. A batteryless RFID label according to claim 1 further wherein said label is attached to a coffee mug.

7. A batteryless RFID label according to claim 1 further wherein said label is attached to a cell phone.

8. A batteryless RFID label according to claim 1 further wherein said bi-state display comprises a multi-line display.

9. A batteryless RFID label according to claim 1 further wherein said bi-state display comprises an electrophoretic display.

10. A stored value payment system comprising a label, said label comprising:
a flexible encapsulation;
means for attaching said label to a non-planar surface of an object;
a circuit having a secure processor with a memory;
a near-field antenna connected to said processor;
and a bi-state display;
wherein said secure processor and said display are powered solely by energy received through said near-field antenna and said label conforms to a shape of a non-planar surface of an object to which it is attached.

11. A stored value payment system according to claim 10 wherein information shown on said display comprises an earned reward.

12. A stored value payment system according to claim 10 wherein information shown on said display comprises a remaining value.

13. A stored value payment system according to claim 12 wherein said remaining value comprises a non-monetary value.

14. A stored value payment system according to claim 10 wherein information shown on said display comprises information of prior use of said stored value payment system.

15. A stored value payment system according to claim 10 further wherein said encapsulation comprises a printed Teslin layer.

16. A stored value payment system according to claim 10 further wherein said label is attached to a coffee mug.

17. A stored value payment system according to claim 10 further wherein said label is attached to a cell phone.

18. A stored value payment system according to claim 10 further wherein said bi-state display comprises a multi-line display.

19. A stored value payment system according to claim 10 further wherein said bi-state display comprises an electrophoretic display.

20. A stored value payment system comprising a label, said label comprising:
a secure processor with a memory;
a near-field antenna connected to said processor;
and a bi-state display; and
a flexible encapsulation layer, wherein said flexible encapsulation layer encapsulates said secure processor, said near-field antenna and said bi-state display and has a window through which information displayed on said bi-state display may be viewed;
wherein said secure processor and said display are powered solely by energy received through said near-field antenna and said label conforms to a shape of a non-planar surface of an object to which it is attached.
